(19) United States
(12) Patent Application Publication
(10) Pub. No.: US 2026/0004940 A1
(43) Pub. Date: Jan. 1, 2026

(54) Enriched with lithium nanoparticles cryogenic deuterium fusion target for whispering gallery mode magnetic inertial fusion with millijoule-class dual-wavelength laser-driven fast ignition

(71) Applicant: Janos Dobos, Pecs (HU)

(72) Inventor: Janos Dobos, Pecs (HU)

(21) Appl. No.: 18/759,898

(22) Filed: Jun. 30, 2024

(51) Int. Cl. G21B 1/19; G21B 1/03

(52) U.S. Cl. CPC G21B 1/19; G21B 1/03

(57) ABSTRACT

The invention reduces the energy level of fast-ignation lasers required for whispering gallery mode magnetic inertial fusion to the millijoule level by applying dual-wavelength laser irradiation to the central plate of a cryogenic deuterium target, which is typically a cubic target. In the center of the cubic target located in a biased magnetic field, there is a nanometer hole for generating a new magnetic field. The target also contains lithium nanoparticles that enhance energy deposition and produce tritium through lithium-neutron reactions, further improving the overall efficiency of the fusion process.

### FIELD OF THE INVENTION

The invention pertains to methods and systems for enhancing cryogenic fusion efficiency through dual-wavelength laser irradiation and nanostructure-augmented magnetic fields.

### BACKGROUND

In 2022 and 2023, the United States' Lawrence Livermore National Laboratory successfully conducted a laser inertial confinement experiment, achieving 3 MJ of energy output from a 2 mm diameter capsule containing compressed fusion material, based on patent WO2012064668A1 “Indirect drive targets for fusion power.” This experiment required 2 MJ of laser energy, derived from 400 MJ of electrical energy, resulting in a net energy loss. The main drawbacks of this method are the absence of a plasma compressing magnetic field, resulting in a very short fusion duration (only a femtosecond), and the significant energy input required, which necessitates the search for more efficient fusion solutions.

Bíró Tamás et al., in their patent WO2023084263A2 “Method for the production of isotopes with high-energy laser pulses assisted by plasmonic amplification,” propose a method to enhance fusion efficiency by packaging unheated fusion fuel in a gel of only a hundred micrometers in diameter and subjecting it to extreme irradiation. Ideally, fusion can occur without generating harmful high-energy neutrons. This approach uses femtosecond laser beams with wavelengths between 600 and 1100 nm and intensities of at least 10\hat{ }13 W/cm2 interacting with plasmonic metal or dielectric nanoparticles to accelerate electrons and ions, potentially achieving or enhancing fusion conditions. However, the energy yield has not yet been measured, and this method does not employ nanotubes or plasma compressing magnetic fields, resulting in fusion durations of only a few femtoseconds.

In their 2020 publication “Generation of megatesla magnetic fields by intense-laser-driven microtube implosions”, M. Murakami and his colleagues used microtube implosion controlled by ultra-intense laser pulses to create ultra-high magnetic fields. The mega-electronvolt hot electrons produced by the laser and formed on the inner wall surface explode towards the cold central axis, where they create a strong peta-ampere spin current density and, as a result, a megatesla magnetic field.

T. Pisarczyk et al. in their study “Strongly magnetized plasma produced by interaction of nanosecond kJ-class laser with snail targets” demonstrated that a polarized whispering gallery mode laser beam of 500 J energy and 350 ps duration directed into a 2 mm diameter snail target of copper generated hot particles that exploded towards the cold central axis. The exploding ions and electrons created a 100 Tesla magnetic field lasting 10 ns and a hot electron density of 10\hat{ }20 electrons/cm3 at the target's center. This method has not been used in inertial fusion.

M. Roth et al. in “Focused Energy, A New Approach Towards Inertial Fusion Energy” described that separating the compression and ignition processes of fusion material leads to more efficient fusion burn with lower energy consumption. They concluded that proton fast ignition is the most credible approach for commercializing fusion energy within inertial confinement fusion. After igniting the hot spot region and initiating supersonic burn waves, the fuel pellet yield is determined by the assembled fuel mass and area density, limited by the available drive laser energy for long-pulse compression beams. This method does not include plasma compression and fast ignition focusing using whispering gallery mode radiation.

The inventor's pending patents U.S. Ser. No. 18/299,151 “Whispering Gallery Mode Fusion Reactor,” U.S. Ser. No. 18/240,362 “Whispering Gallery Mode Fusion Reactor with Fast Ignition,” and U.S. Ser. No. 18/397,126 “Whispering Gallery Mode Fusion Power and Rocket Propulsion” describe a fusion reactor where the compression and ignition of fusion material are driven by the compressive magnetic field of whispering gallery mode radiation. This method utilizes the advantage that any radiation, including neutron, ion, alpha, beta, gamma, X-ray, or laser radiation, can be forced into a whispering gallery mode at small incidence angles. The main drawback is the requirement for kJ-class laser beams.

### SUMMARY OF INVENTION

The invention reduces the energy required for whispering gallery mode magnetic inertial fusion fast ignition lasers to millijoule levels by employing dual-wavelength laser irradiation on the central region of a cryogenic deuterium target. Situated in a pre-stressed magnetic field, the target contains nanometer-sized hole. In one embodiment, a 50 millijoule laser pulse provides high energy density, while the 10 fs ultrashort pulse duration and the 10\hat{ }16 W/cm2 peak power ensure efficient energy transfer. The first set of laser beams, with a wavelength of 1053 nm, directed from opposite sides towards the center of a 200 nm thick target, generate fusion plasma, heating and compressing the deuterium to fusion temperatures. Based on the PIC simulations, the particle density (n) was 10\hat{ }22 particles/cm3 and the closing time of the magnetic field (t): 10 ns, thus creating the necessary Lawson criteria for fusion, which for deuterium is nτ≥10\hat{ }16 s/cm3. Similarly parameterized 532 nm laser beams, also directed from opposite sides, ignite the target's center, initiating a burn that propagates through the entire target, compressed by the whispering gallery mode-induced magnetic field. The laser-generated hot electrons and ions from the inner hot wall of nano hole explode towards the cold center. A uniform magnetic field induces Larmor gyrations of the imploding particles, producing ampere current density and generating tesla magnetic fields. These fields confine electrons and ions, ensuring they deposit their energy within the target, extending the fusion burn. The target also incorporates lithium nanoparticles, which enhance energy deposition and generate tritium through lithium-neutron reactions, further improving the fusion process's overall efficiency. The invention is best understood with reference to the drawings.

### BRIEF DESCRIPTION OF DRAWINGS

FIG. 1: Depicts the laser-driven whispering gallery mode mirror magnetic field generator, whispering gallery mode laser beam, and the pre-seeded, plasma compressing, ion and electron trapping mirror magnetic field.

FIG. 2: Illustrates the cryogenic target with the center spot and laser beam inlet openings.

FIG. 3: Shows the fast ignition laser beam and the path of the radiation released during fusion.

FIG. 4: Depicts the generated magnetic fields that trap the electron-ion flow released during fusion.

FIG. 5: Illustrates the nano lithium that convert neutrons released during fusion into tritium.

FIG. 6, FIG. 7, FIG. 8, FIG. 9: Illustrates the cryogenic fusion fuel for whispering gallery mode magnetic inertial fusion with millijoule-class laser-driven fast ignition and depict the elements of the fusion process according to the invention.

FIG. 10: Shows the cryogenic beam target generated by the cryostat according to the invention.

FIG. 11: Depicts the fast ignition first laser irradiation and fast ignition second laser.

### DETAILED DESCRIPTION OF INVENTION

Drawings outline a method for enhancing whisperin gallery mode magnetic-inertial fusion efficiency through the use of dual-wavelength laser irradiation on a cryogenic deuterium target, augmented with structural features and nanoparticles to generate strong magnetic fields and improve particle confinement and energy deposition.

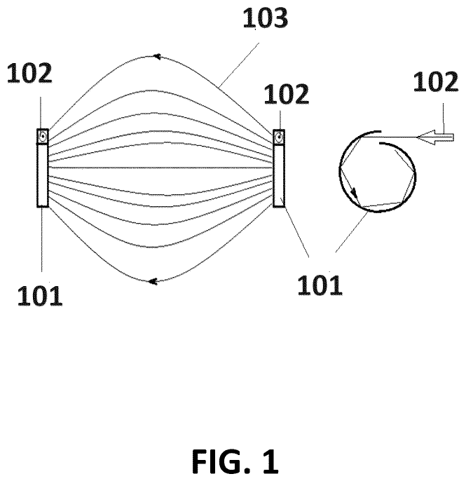

FIG. 1 illustrates the 101 laser-driven whispering gallery mode mirror magnetic field generator, 102 whispering gallery mode laser beam, and 103 pre-seeded, plasma compressing, ion and electron trapping primary-magnetic-field.

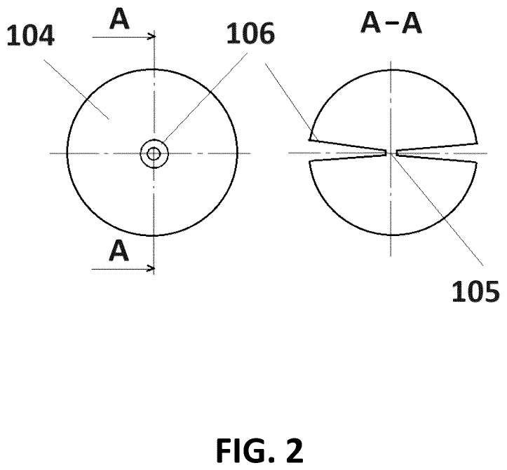

FIG. 2 depicts the 104 cryogenic target with 105 center plate, 106 laser beam inlets.

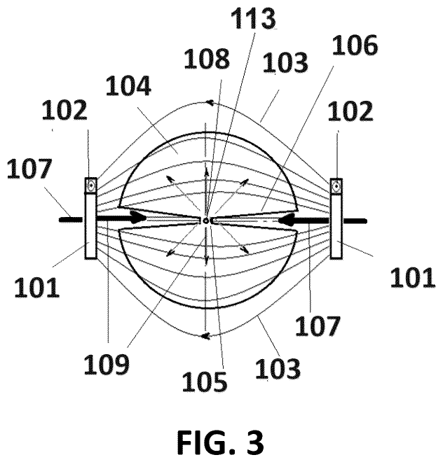

FIG. 3 shows the 101 laser-driven whispering gallery mode mirror magnetic field generator, 102 whispering gallery mode laser beam, 103 pre-seeded, plasma compressing, ion and electron trapping primary-magnetic-field, 104 cryogenic target with a 105 center plate, 106 laser beam inlets, 107 directed against each other fast ignition lasers beams with millijoule-class energy, femtosecond pulse duration, and intensity of at least 10\hat{ }16 W/cm2, 108 hot spot, and 109 neutron, gamma, electron, ion radiation released during fusion, 113 nanohole.

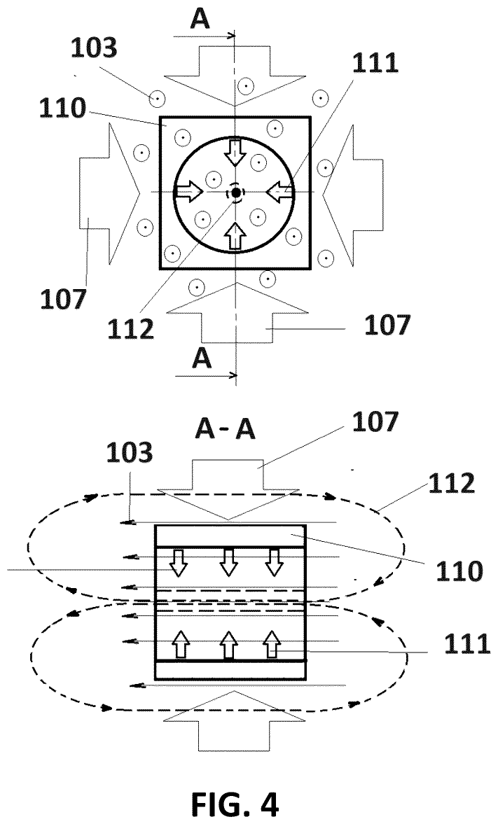

FIG. 4 depicts the 110 cubic target, 103 pre-seeded, plasma compressing, ion and electron trapping primary-magnetic-field, 107 directed against each other fast ignition lasers beams with millijoule-class energy, femtosecond pulse duration, and intensity of at least 10\hat{ }16 W/cm2, 113 nanohole, 114 neutron-slowing, gamma ray-absorbing lead nanostructures, and 115 neutron-to-tritium converting lithium nanostructures, 111 electron-ion implosion towards cold center, 112 ion and electron trapping secondary-magnetic-field. This design choice helps stabilize the implosion process.

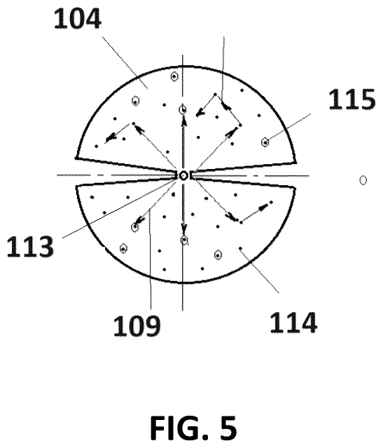

FIG. 5 illustrates the 104 cryogenic target with 109 neutron, gamma, electron, and ion radiation released during fusion, 113 nanohole including 114 neutron-slowing, gamma ray-absorbing lead nanostructures, and 115 neutron-to-tritium converting lithium nanostructures.

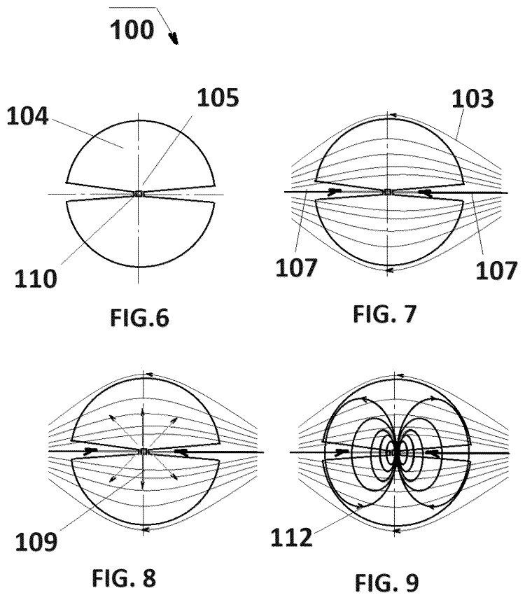

FIG. 6, FIG. 7, FIG. 8, FIG. 9 Illustrates the 100 enriched with lithium nanoparticles cryogenic deuterium fusion target for whispering gallery mode magnetic inertial fusion with millijoule-class dual-wavelength laser-driven fast ignition and 112 depict the elements of the fusion process according to the invention, depict the process of forming the ion and electron trapping secondary-magnetic-field that trap the electron-ion flow released during fusion in the 104 cryogenic target with a 105 center plate 110 cubic target. Drawings include the 103 pre-seeded, plasma compressing, ion and electron trapping primary-magnetic-field, 107 directed against each other fast ignition lasers beams with millijoule-class energy, femtosecond pulse duration, intensity of at least 10\hat{ }16 W/cm2, 108 neutron, gamma, electron, and ion radiation released during fusion.

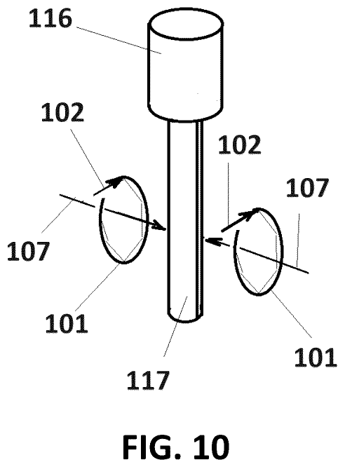

FIG. 10 shows the 117 cryogenic beam target generated by the 116 cryostat, 101 laser-driven whispering gallery mode mirror magnetic field generator, 102 whispering gallery mode laser beam, and 107 directed against each other fast ignition lasers beams with millijoule-class energy, femtosecond pulse duration, and intensity of at least 10\hat{ }16 W/cm2.

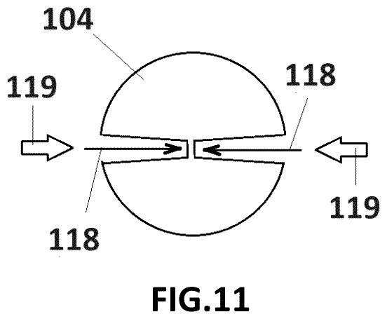

FIG. 11 depicts the 104 cryogenic target with 107 directed against each other fast ignition lasers beams with millijoule-class energy, femtosecond pulse duration, and intensity of at least 10\hat{ }16 W/cm2 characterized by that 118 comprising a basic wavelength first laser beam and a 119 multiplied wavelength second laser beam. For example: The wavelength of the first laser beam is 670.8 nm, which resonates with the resonance frequency of the Lithium-6 isotope. Through the plasma resonance of Lithium-6, it can amplify the received light energy and then distribute it evenly to initiate the fusion fast ignition. This process is completed by a second laser beam with a wavelength that is half of the first one, i.e., 335 nm.

Advantages of the Invention: Enhanced Fusion Efficiency: Dual-Wavelength Laser Irradiation: Utilizing lasers with different wavelengths (for example: 670.8 nm and 335 nm) optimizes energy deposition and enhances plasma dynamics, leading to more efficient fusion ignition.

Strong Magnetic Field Generation: The invention leverages Larmor motion to generate strong magnetic fields that confine electrons and ions within the target. This confinement ensures that the energy is deposited effectively, extending the fusion burn to the entire target and improving the overall efficiency of the fusion process.

Advanced Nanostructures: Incorporation of Lead and Lithium Nanoparticles: These nanoparticles slow down neutron radiation, absorb gamma radiation, and convert neutrons into tritium through lithium-neutron reactions. This not only enhances energy deposition but also sustains the fusion process by generating additional tritium for subsequent fusion reactions.

Use of Nanotubes and Holes: The presence of nanometer-sized holes and metallic or dielectric nanotubes in the target helps generate the required magnetic fields and improves particle confinement, further enhancing the fusion efficiency.

Reduced Energy Requirements: Millijoule-Class Energy Levels: The invention achieves fast fusion ignition using millijoule-class energy levels, significantly lower than the kilojoule levels required in conventional fusion methods. This reduction in energy requirements makes the process more practical and cost-effective.

Compact and Scalable Design: Whispering Gallery Mode Radiation: The use of whispering gallery mode radiation allows for efficient compression and ignition of the fusion material, making the setup compact and potentially scalable for various applications.

Energy Production: The invention has the potential to be used in the development of compact, efficient fusion reactors for generating clean and sustainable energy. By reducing the energy input requirements and improving the overall efficiency, this technology could pave the way for practical and economically viable fusion power plants.

Medical Applications: The precise control over energy deposition and the ability to generate strong magnetic fields could be utilized in medical applications, such as targeted radiation therapy for cancer treatment. The technology's ability to confine particles and control their behavior at a nanometer scale offers significant advantages in precision medicine.

Space Exploration: The compact and efficient design of the fusion reactor could be used in space propulsion systems, providing a high-energy, long-duration power source for deep space missions. This would enable faster travel times and reduce the reliance on traditional chemical propulsion systems.

Scientific Research: The advanced capabilities of the invention make it suitable for various scientific research applications, including high-energy physics experiments, material science studies, and the exploration of new fusion fuels and reactions. The precise control over fusion conditions can lead to breakthroughs in our understanding of fundamental physical processes.

Summary: Based on the PIC simulations the invention presents significant advancements in nuclear fusion technology by combining dual-wavelength laser irradiation, strong magnetic field generation through nanostructures, and the incorporation of lead and lithium nanoparticles. These innovations lead to enhanced fusion efficiency, reduced energy requirements, and a compact, scalable design. The potential applications span across energy production, medical treatments, space exploration, and scientific research, making this invention a promising solution for multiple high-impact fields.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

1. Enriched with lithium nanoparticles cryogenic deuterium fusion target for whispering gallery mode magnetic inertial fusion with millijoule-class dual-wavelength laser-driven fast ignition (100) characterized by that comprising: lasers-driven whispering gallery mode mirror magnetic field generator (101), whispering gallery mode laser beam (102), pre-seeded, plasma compressing, ion and electron trapping primary-magnetic-field (103), cryogenic target (104) with laser beam inlets (106) directed in opposite directions, which are separated by a center plate (105), directed against each other fast ignition lasers beams with millijoule-class energy, femtosecond pulse duration, and intensity of at least 10\hat{ }16 W/cm2 (107), neutron, gamma, electron, and ion radiation released during fusion (109), nanohole (113), neutron-to-tritium converting lithium nanostructures (115), electron-ion implosion towards cold center (111) in nanohole (113), ion and electron trapping secondary-magnetic-field (112) from the nanohole (113).

2. The directed against each other fast ignition lasers beams with millijoule-class energy, femtosecond pulse duration, and intensity of at least 10\hat{ }16 W/cm2 (107) according to claim 1, characterized by that comprising a basic wavelength frequency first laser beam (118) and a multiplied wavelength second laser beam (119).

3. The center plate (105) according to claim 1, characterized that cubic target (110), in which there is a nanohole (113).
